(19) United States
(12) Patent Application Publication
(10) Pub. No.: US 2022/0230153 A1
(43) Pub. Date: Jul. 21, 2022

(54) PAYMENT MANAGER HAVING DATA ENRICHMENT TOOL

(71) Applicant: Wells Fargo Bank, N.A., San Francisco, CA (US)

(72) Inventors: Mattie Morris, Chandler, AZ (US); Gregory Hansen, Palo Alto, CA (US)

(21) Appl. No.: 17/004,576

(22) Filed: Aug. 27, 2020

Related U.S. Application Data
(63) Continuation of application No. 14/102,334, filed on Dec. 10, 2013, now abandoned.

(51) Int. Cl. G06Q 20/14

(52) U.S. Cl. CPC G06Q 20/14

(57) ABSTRACT

A computer-implemented method includes receiving a payment file. The payment file includes payment data and transactional data for payments to be made on behalf of a commercial enterprise customer. The method includes: determining a plurality of segment collections in the payment file, each segment collection comprising a plurality of elements delimited by an opening syntactic tag and a closing syntactic tag; generating a payment key associated with the customer profile according to metadata and specific segments of the payment file; determining a customer identification number associated with the customer profile; determining a payment method identification value from a first specific element; identifying a data enrichment key designated by the customer using a data enrichment configuration and located within a customer-designated segment of the plurality of segment collections; enriching the payment file with supplemental payment data; transmitting a payment signal to a payment computer system to effect payment to the recipients.

### CROSS-REFERENCE TO RELATED PATENT APPLICATIONS

This application is continuation of U.S. application Ser. No. 14/102,334, filed on Dec. 10, 2013, which is incorporated herein by reference in its entirety.

### BACKGROUND

The present disclosure generally relates to payment automation services. Specifically, the present disclosure generates to a payment automation service that includes a data enrichment tool configured to enrich data contained in payment files received from payees.

### SUMMARY

According to an embodiment, a computer-implemented method processes a payment request from a customer. Payment data is received from a customer. The payment data includes transactional data for payments to be made on behalf of the customer to payment recipients. The transactional data specifies payment amounts and identifies the payment recipients. A payment key is determined from the payment data. A data repository is accessed based on the payment key. Supplemental payment data is retrieved from the data repository. A payment signal is transmitted to a payment computer system (e.g., computerized check printing system, credit card network, etc.) to effect payment to the recipients in accordance with the payment data and the supplemental payment data.

According to an embodiment, a computer-implemented method processes a payment request from a customer. The method includes receiving, from an accounts payable system, by a payment manager logic of a bank computing system comprising at least one processor and non-transitory computer-readable media, the computer-readable media having embodied thereon the payment manager logic, a payment file. The payment file includes payment data from a commercial enterprise customer. The payment file includes transactional data for payments to be made on behalf of the commercial enterprise customer to payment recipients, wherein the payment data is associated with a parent company or a subsidiary of the commercial enterprise customer, or combination thereof. The transactional data includes payment amounts and payment recipient data on behalf of the parent company, the subsidiary, or the combination thereof. The method includes determining whether a customer profile associated with the parent company or the subsidiary of the commercial enterprise customer comprises a data enrichment configuration, the data enrichment configuration provided by the customer via a graphical user interface structured to interact with payment manager logic. The method includes determining, via the payment manager logic, a plurality of segment collections in the payment file, each segment collection comprising a plurality of elements delimited by an opening syntactic tag and a closing syntactic tag. The method includes generating, via the payment manager logic, a payment key associated with the customer profile according to metadata and specific segments of the payment file. Generating the payment key includes determining, from the metadata of the payment file, a customer identification number associated with the customer profile. Generating the payment key includes determining a payment method identification value from a first specific element identified based on a first opening syntactic tag and a first closing syntactic tag, the first specific element residing within the plurality of elements. Generating the payment key includes identifying a data enrichment key designated by the customer in the data enrichment configuration, wherein the data enrichment key is located within a customer-designated segment of the plurality of segment collections, wherein the customer-designated segment is identified by a second opening syntactic tag and a second closing syntactic tag. The payment key includes the customer identification number, the payment method identification value, and the data enrichment key. The method includes locating, via a data enrichment tool and based on the data enrichment key and the determination that the customer provided the data enrichment configuration, a data structure corresponding to the data enrichment key. The method includes retrieving, via the data enrichment tool, supplemental payment data comprising logistics data from the data structure corresponding to the data enrichment key. The method includes enriching, via the data enrichment tool, the payment file with the supplemental payment data from the data structure corresponding to the data enrichment key. The method includes transmitting, via the payment manager logic, a payment signal to a payment computer system to effect payment to the recipients in accordance with the payment data, the payment key, and the supplemental payment data.

According to an embodiment, a computer system which includes a processor, a memory and computer-readable media processes a payment request from a customer according to computer-implemented methods described herein.

According to an embodiment, a computer-executable medium or media has instructions embodied thereon that, when executed by a processor, carry out computer-based operations to process a payment request from a customer according to computer-implemented methods described herein.

### BRIEF DESCRIPTION OF THE DRAWINGS

FIG. 1 shows a data processing system that may be used to implement systems and methods described herein according to an example embodiment.

FIG. 2 shows an example of a method for processing a payment request from a customer according to an example embodiment.

FIG. 3 shows a payment key arrangement according to an exemplary embodiment.

FIG. 4 shows an example of another method for processing a payment request from a customer according to an example embodiment.

FIG. 5 shows an example of a customer ID, a data enrichment key, and a payment method being extracted from a payment file, according to an exemplary embodiment.

FIG. 6 shows a portion of a data structure containing enrichment data and a portion of a payment file into which the enrichment data is inserted, according to an exemplary embodiment.

### DETAILED DESCRIPTION

According to example embodiments, a data enrichment tool is provided for a payment automation service. The payment service is configured to send payments to recipients responsive to instructions received from a customer (e.g., a commercial enterprise). In an example embodiment, the payment service is provided by a bank and the customers have accounts at the bank from which funds are sent to the recipients. The data enrichment tool may allow customers to store logistical information for the payments in a computer system operated by the payment service rather than providing such information in payment instruction files the customers deliver to the payment service each time payments are made. The data enrichment tool may be used to provide processing and routing data that is not provided by the customers' accounts payable systems. The data enrichment tool may be used to enrich payment files received from the customer with the appropriate additional content. This enrichment may be completed prior to any payment-specific processing.

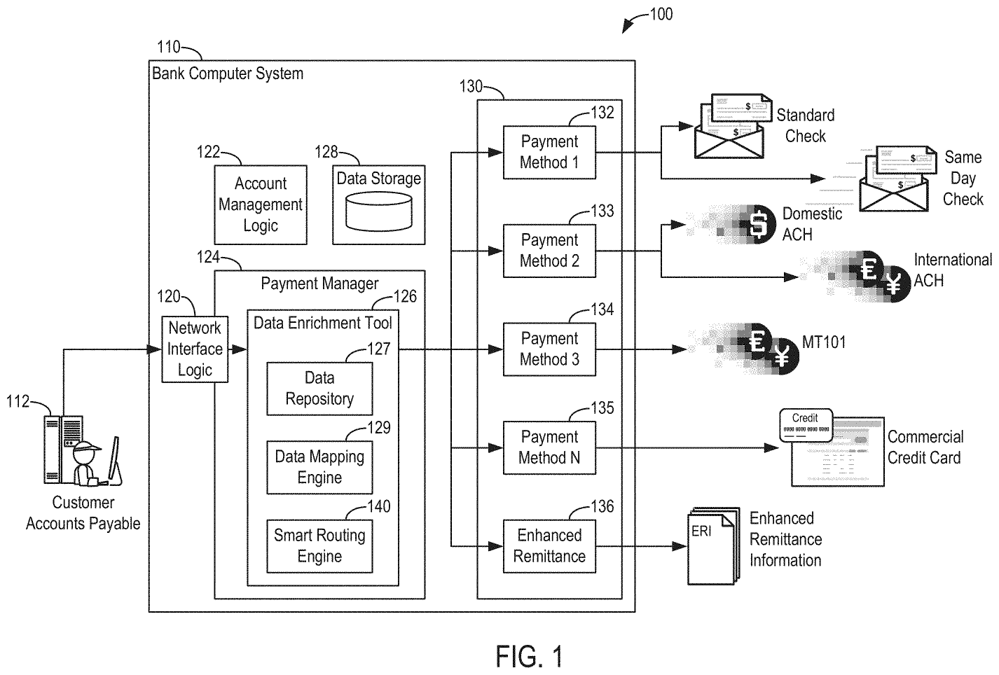

Referring first to FIG. 1, FIG. 1 shows a data processing system 100 that may be used to implement the systems and methods described herein according to an example embodiment. The data processing system 100 includes a bank computer system 110 that may be configured to maintain bank accounts held by account holders (e.g., customers). For example, the bank computer system 110 may comprise a system of interconnected servers that, for example, execute stored program instructions to implement the operations described herein. Customers may access the system 110 to send payment instructions, configure payment settings, receive account information and/or perform other operations using a variety of customer computer systems 112. The customer computer systems 112 may include servers, desktop computers, laptop computers, and/or other types of computers. The customer computer systems 112 may access the system 100 through a communication network 118 which may, for example, include the Internet, telephone networks, wireless networks, point-to-point networks, and/or other networks.

Bank computer system 110 may include network interface logic 120, account management logic 122, payment manager logic 124, data storage system 128, and payment interfaces 130. Network interface logic 120 may be used to establish connections with computer systems 112 and to permit users to access accounts in system 110 by way of network 118. For example, such an interface may be used to receive bulk transfers of data from the customers, for example, payment files specifying various payments to be made to recipients. The network interface logic 120 may also be used by customers to interact with the payment manager logic 124. For example, network interface logic 120 may comprise one or more web servers that provide a graphical user interface (e.g., a series of dynamically-generated web pages) for customers that access system 110 through the web. The graphical user interface may be used by the customer to interact with the payment manager 124. For example, the graphical user interface may be used by the customer to configure one or more profiles for the payment manager logic 124. In other embodiments, the profiles may be configured by a customer service employee of the bank on behalf of the customer.

The account management logic 122 may be configured to perform account processing to process transactions in connection with the accounts of the account holders, such as account debits and credits to checking and savings accounts, credits and debits to home mortgage and home equity accounts, credits and debits to student loan accounts, and so on. For example, in the context of checking accounts, the transactions may also include electronic bill payment transactions in which monies from the checking account of the user are used to pay bills received by the user. The account management logic 122 may also be configured to perform processing in connection with other activities associated with the servicing and maintenance of the accounts of the account holders. The account management logic 122 may access and update information stored in the data storage system 128, which stores details regarding financial institution accounts including information for each financial transaction that occurred.

The payment manager logic 124 provides a payment automation service. As previously indicated, the payment manager logic 124 may be configured to receive electronic payment files from customers for processing. To process these payments, the payment manager logic 124 may utilize transactional payment information and logistical payment information. The transactional payment information comprises information about who is getting paid, how much, what the payment is for, and so on. The logistical payment information comprises information about message formats, delivery methods, payment system IDs, and so on.

In an exemplary embodiment, the transactional payment information is included in a payment file received from the customer. The payment files may be generated by an accounts payable systems operated by the customer (e.g., internal accounting systems, enterprise resource planning systems, treasury workstations, in-house solutions, and so on). Commercially available accounts payable systems often natively support basic transactional payment data, thereby facilitating the process of extracting it for payment manager logic 124. Commercially available accounts payable systems often do not adequately support the logistical enrichment data.

The payment manager logic 124 includes a data enrichment tool 126. The data enrichment tool 126 may allow customers to store payment logistical information in the bank computer system 110, rather than providing it in the files they deliver to the payment manager logic 124. The payment manager logic 124 may then utilize data enrichment tool 126 to enrich the received file with the appropriate additional content. The enrichment may be completed prior to any payment method specific processing.

The payment interfaces 130 may include various types of interfaces 132-135 for various payment methods. Such payment methods may include, for example, regular check delivery, same day check delivery, domestic automated clearing house (ACH) delivery, international ACH delivery, credit card payment, and/or other payment methods. The interfaces 130 may include program logic configured to interface the bank computer system 110 with the computer system of the respective payment service/system.

Also shown in FIG. 1 is an enhanced remittance interface 136. Enhanced remittance interface 136 may be configured to generate enhanced remittance information. The enhanced remittance information may include information such as details about the remitter, the beneficiary, how and where funds are sent, the fee, how much money the recipient will receive, foreign exchange (FX) rate (if applicable) for the transaction, and so on. The enhanced remittance information may include information obtained from the data repository 127, such as a template to be used when issuing enhanced remittance information. Such a template may include name and address information to be included with the remittance information provided to the payee (which may be different than the name and address of the customer, e.g., if the payment is being made on behalf of a subsidiary).

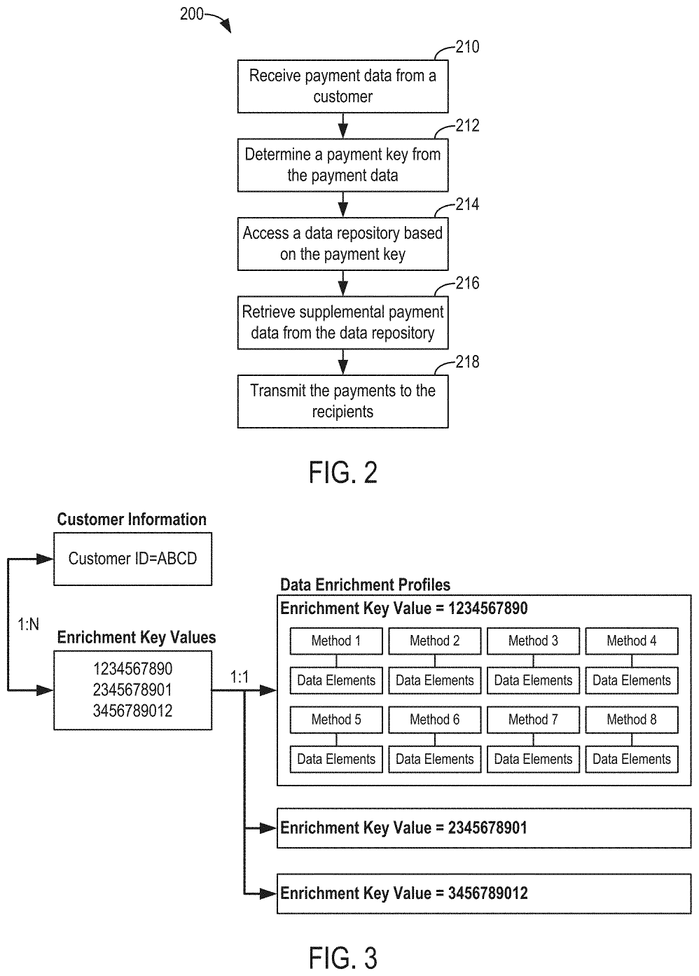

Referring now to FIG. 2, a method for processing a payment request from a customer is shown. For purposes of providing an example, assume that a commercial enterprise comprises a parent company and a number of subsidiaries that each use the same accounts payable resources of the parent company and make payments from the same bank account. However, when sending payment by check, each of the different subsidiaries may wish to have different information appear on the check. For example, if each of the subsidiaries has a different name and a different business address, the subsidiaries may each wish to customize the information appearing on the check to correctly reflect the name and address of the respective subsidiary. As will be appreciated, depending on the payment method and other parameters, other types of content may also be configured.

In such a scenario, the customer may have a separate profile configured for each of the subsidiaries. For each subsidiary, the profile may include a customized check template that reflects, e.g., the name and address of the respective subsidiary. If the subsidiaries use multiple payment methods, then the customer may have a separate profile configured for each of the payment methods for each of the subsidiaries.

At step 202, the payment manager logic 124 receives payment data from a customer. The payment data may include transactional data for payments to be made on behalf of the customer to payment recipients. For example, the transactional data may specify payment amounts and identify the payment recipients.

At step 204, the payment manager logic 124 determines a payment key based on the payment data. In an example embodiment, the payment key is embedded in the payment file and may be extracted from the payment file. The payment key is used to access a data repository 127. In an example embodiment, the payment key may be used as an index to a lookup table. In other embodiments, the payment key may be used as an index to other more complicated data structures.

At step 206, the data enrichment tool 126 accesses a data repository 127 based on the payment key and retrieves supplemental payment data from the data repository 127. The supplemental payment data includes logistics data specifying logistics of making the payments to the payment recipients. The logistics data is data that is preconfigured by the customer (or by a customer service representative on behalf of the customer) and that is stored in the data repository 127 prior to receipt of the transactional data. For example, in the context of the present example, the logistics data may include a check template that includes the name and address of the subsidiary on behalf of whom the payment is being sent.

At step 208, the payment manager logic 124 transmits a payment signal to a payment computer system to effect payment to the recipients in accordance with the payment data and the supplemental payment data. For example, the payment manager logic 124 may transmit the payment signal via interface 132. The interface 132 may interface with a computerized automated check printing system to ensure that a check is printed in conformance with the template and is sent to the intended payment recipient. As other examples, the interface 132 may interface with computer systems associated with a credit card network, automated clearing house system, third-party proprietary payment networks, and so on.

Referring now to FIGS. 3-6, FIG. 3-6 show additional details according to one example embodiment are described. Referring first to FIG. 3, the payment key may comprise a plurality of sub-data elements including a customer identifier (ID), a data enrichment key, and a payment method ID. For example, the different customer IDs may be used to distinguish different customers of the payment service, the different enrichment keys may be used to distinguish different subsidiaries of each of the different customers, and the different payment method IDs may be used to distinguish each of the different payment methods (and thereby different enrichment content) that may be used by each of the different subsidiaries of each of the different customers. For each payment key (customer ID/data enrichment key/payment method ID combination), a set of data elements 310 may be stored in the data repository 127.

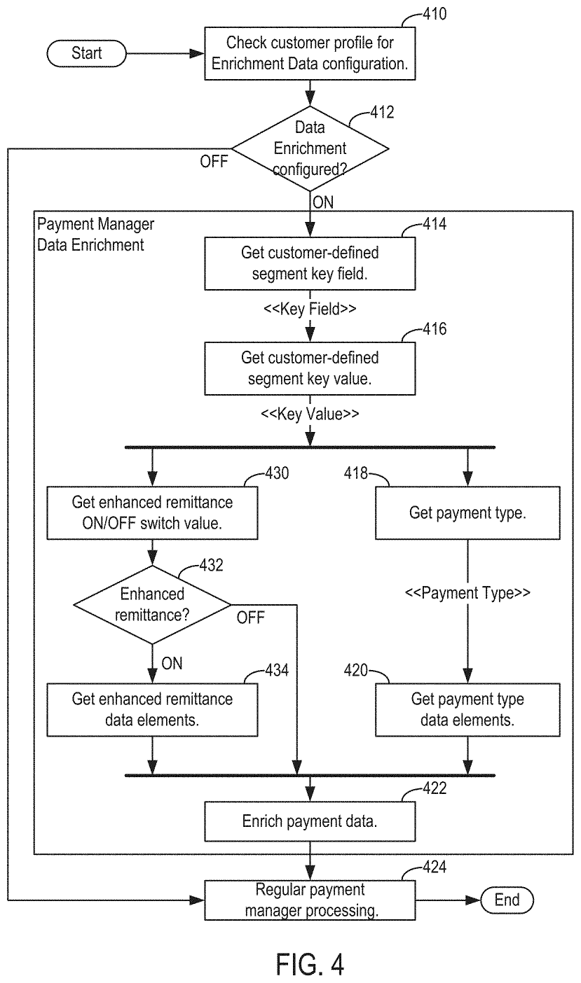

Referring now also to FIG. 4, FIG. 4 provides a more detailed example of a method for processing a payment request from a customer in which the customer is able to specify separate sub-entities and separate payment methods for each sub-entity as just described. At step 410, the payment manager logic 124 receives a payment file from the customer and determines whether the customer has configured a profile in the data enrichment tool 126. The customer may opt in advance whether to use the data enrichment tool. If the customer opts to use the data enrichment tool 126, then the customer is provided with the ability to configure a profile for the data enrichment tool 126, or to have a profile configured by a customer service representative of the bank. The payment manager logic 124 may extract the customer ID from the payment file and use the customer ID to look up whether the customer has a profile configured. For example, a data enrichment flag associated with the customer may be set to on or off, depending whether the customer has a profile configured. At step 412, the data enrichment flag is examined to determine whether the customer has a profile configured. If no profile is configured, then the process skips to steps to step 424, where payment processing occurs without any data enrichment.

Conversely, assuming the customer has a profile configured, then the process proceeds to step 414. At step 414, the data enrichment tool 126 determines the field segment in the payment file that contains the data enrichment key. In an example embodiment, the data enrichment key may be contained in a customer-specified segment of the payment file. For example, the payment file may include various standard data segments, such as a segment for an organization name, a segment for an organization ID, a segment for a organization account ID, and/or other segments, and the customer may be given the ability to select one of these segments to be used as a data enrichment key. In an example where the data enrichment key is a customer-specified segment of the payment file, then, based on the customer ID, the data enrichment tool 126 may determine which data segment of the payment file is to be used as the data enrichment key. Such an arrangement may permit the arrangement of FIGS. 3-6 to be backward-compatible with standard/commercially available accounts payable systems that may have predefined/standardized data segments. In other embodiments, a new data segment may be added to the payment file which is used exclusively as a data enrichment key.

At step 416, the data enrichment tool 126 extracts a value from the field that is determined to contain the data enrichment key. For example, if it is determined that the customer specified a company ID field as being the field that contains the data enrichment key, then the data enrichment key is set equal to the value contained in the company ID field. As will be appreciated, if the customer has N subsidiaries and has configured N different profiles for the different subsidiaries, then the company ID may have N different potential values for that customer.

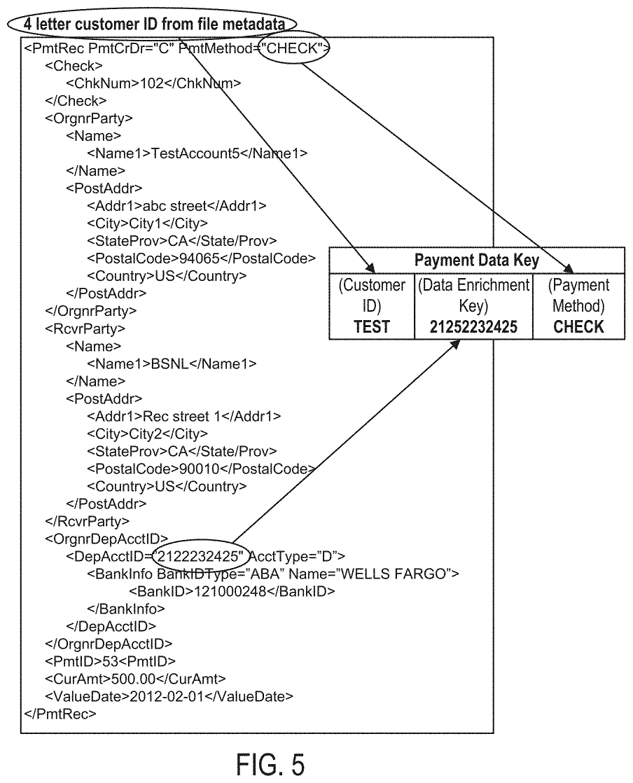

At step 418, the payment method is determined. The payment method may be determined based on the payment method ID, which may be a standard field in the payment file. As previously indicated, in the embodiment of FIGS. 3-6, the payment key comprises a combination of the customer ID (determined at step 410), the data enrichment key (determined at step 416), and the payment method ID. Hence, once the payment method ID is determined at step 418, the complete payment key has been determined. FIG. 5 shows an example of a customer ID, a data enrichment key, and a payment method ID being extracted from a payment file.

Referring again to FIG. 4, at step 420, the data enrichment tool 126 accesses a data repository 127 based on the payment key and retrieves supplemental payment data from the data repository 127. The supplemental payment data includes logistics data specifying logistics of making the payments to the payment recipients. The logistics data is data that is preconfigured by the customer (or by a customer service representative on behalf of the customer) and that is stored in the data repository 127 prior to receipt of the transactional data.

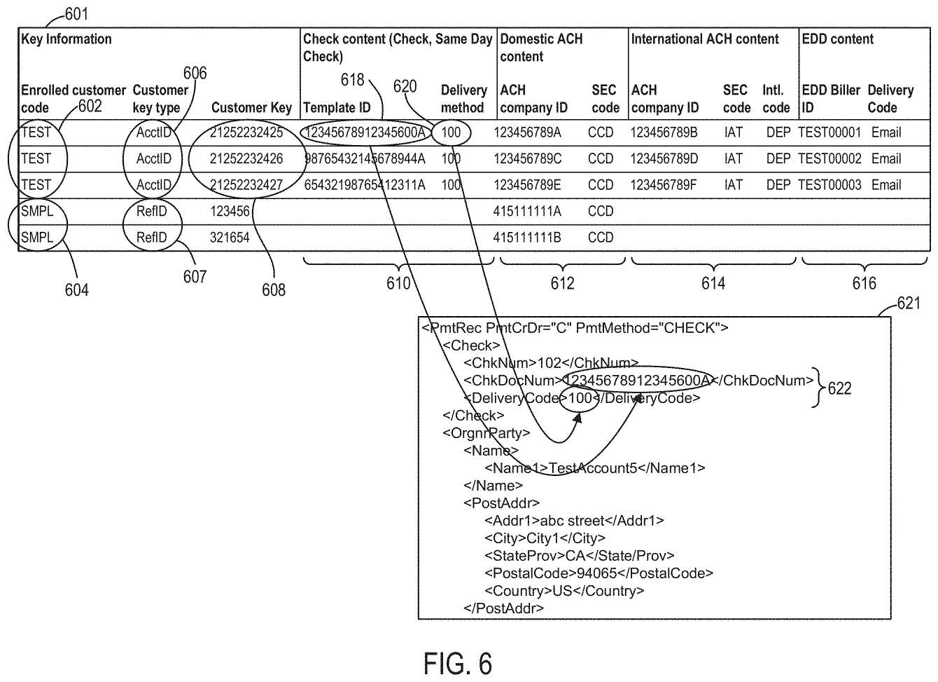

At step 422, the payment file is enriched with the logistical data retrieved from the data repository 127. FIG. 6 shows additional details of an example of the payment file being enriched with logistical data. Specifically, FIG. 6 shows a portion of a data structure 601 containing enrichment data and a portion of a payment file 621 into which the enrichment data is inserted. As shown in FIG. 6, a data structure 601 includes entries for first and second customers: “TEST” (602) and “SMPL” (604). The customer TEST has selected the AcctID segment to be the data enrichment key, and the customer SMPL has selected the RefID segment 607 to the data enrichment key. Focusing on the customer TEST, also shown are values 608 which each correspond to a different sub-entities. Each different subentity has a row of data in the data structure, with each of the different rows including enrichment data for different payment types. Columns 610, 612, 614, and 616 correspond to the different payment types.

In the example FIG. 6, the payment key that is extracted corresponds to that shown in FIG. 5. Hence, the payment key is the combination of the customer ID (“TEST”), the data enrichment key (“2125223425”), and the payment method ID (“CHK”). For this payment key, the data structure includes enrichment data including a template ID (“12345678912345600A”) and a delivery method (“100”). The template ID may specify a template that is to be used in printing the check, e.g., which may include the name and address of the specific sub-entity on behalf of whom the check is being sent. The delivery method may specify the check delivery method that is to be used for sending the check (e.g., regular delivery vs. same day delivery). The enrichment data that is retrieved from the data repository 127 may then be processed by mapping engine 129 and inserted into the payment file 621, as shown at field 622 of the payment file 621.

Referring again to FIG. 4, at step 424, the payment manager logic 124 transmits a payment signal to a payment computer system to effect payment to the recipients in accordance with the payment data and the supplemental payment data. For example, the payment manager logic 124 may transmit the payment via interface 132. The interface 132 may interface with a check printing service to ensure that a check is printed in conformance with the template and is sent to the intended payment recipient.

As previously indicated, in some instances, enhanced remittance information may also be sent. Hence, as shown in FIG. 4, a flag indicating whether enhanced remittance information is to be sent is examined at step 430. At step 430, a determination is made as to whether enhanced remittance information is to be sent based on the status of the flag. Assuming such information is to be sent, then the enhanced remittance data elements are retrieved from the data repository at step 434. This information is then used when the payment file is enriched (at step 422, previously described).

As has been indicated, the payment manager logic 124 may interface with a variety of different types of payment systems. Examples of such systems including check systems (CHK), same day check systems (SDC), domestic automated clearing house systems (DAC), international automated clearing house systems (IAC), credit card systems (CCR), and so on. As will also be appreciated, the data enrichment tool 126 may be used to enrich payment files with a variety of different types of data. Table 1 below provides examples of different types of logistical data that may be stored in the data repository 127 for the afore-mentioned payment types. As will be appreciated, other types of logistical data may also be stored for each of these payment types.

TABLE 1

| Payment | Logistical Data | |
|---|---|---|
| Type | Element | Description |
| Check, Same | CheckTemplate | Definition: Check-face Style ID |
| Day Check | Number | that's passed to Print Services |
| | | identifying what template to use |
| | | to generate the physical check |
| | | issued as payment. |
| Check, Same | CheckDelivery | Definition: Code value passed to |
| Day Check | Code | Print Services identifying the |
| | | mail delivery service to be used |
| | | for payment. All standard mail |
| | | codes supported. |
| Domestic ACH | ACHCompanyID | Definition: ID representing the |
| | | paying party's ACH system |
| | | profile passed to ACH for use in |
| | | the execution of domestic |
| | | payments. ACH company/batch |
| | | ID is assigned by the payment |
| | | service to identify customer on |
| | | the ACH network; it is always |
| | | 10 characters in length. |
| | | The same field is used for |
| | | domestic and international but |
| | | the payment types differ. |
| Domestic ACH | PDPHandling Code | Definition: Code that Indicates |
| | | a payment is to be processed as |
| | | PDP. If PDP is not used, skip |
| | | this element. Values are: |
| | | T Payment Delivery Preferences |
| International | ACHCompanyID | Definition: ID representing the |
| ACH | | paying party's ACH system |
| | | profile passed to ACH for use in |
| | | the execution of domestic |
| | | payments. ACH company/batch |
| | | ID is assigned by the payment |
| | | service to identify customer on |
| | | the ACH network; it is always |
| | | 10 characters in length. |
| | | The same field is used for |
| | | domestic and international but |
| | | the payment types differ. |
| Commercial | CEOCompanyID | Definition: ID passed to CCR |
| Credit Card | | that identifies the profile of the |
| | | company for whom payments are |
| | | being executed. For CCR, CEO |
| | | Company ID may be different |
| | | than what is associated with other |
| | | CEO services; should be validated |
| | | with CCER prior to use. |
| Commercial | ContactName | Definition: This is the name of the |
| Credit Card | | person or department that payee |
| | | can contact for questions about the |
| | | transaction. If not provided, PMGR |
| | | has default logic to populate field. |
| Commercial | ContactPhone | Definition: This is the Contact |
| Credit Card | Number | Name's phone number used by |
| | | payee for questions about the |
| | | transaction. If not supplied, PMGR |
| | | defaults to blank. |
| Commercial | ContactPhone | Definition: This element |
| Credit Card | NumberQualifier | accompanies the contact phone |
| | | and if used, indicates whether |
| | | the number is: |
| | | TE for telephone |
| | | FX for fax |
| | | TL for telex. |
| Commercial | MasterAccount | Definition: This is the AP Control |
| Credit Card | NumberAlias | account number or the MAN; it is |
| | | 16 digits. A user-defined MAN is |
| | | 15 alphanumeric characters; it is |
| | | created by the customer or by |
| | | CCER and is a key that connects |
| | | back to the MAN. CCR uses the |
| | | MAN to issue a single-use |
| | | control account number (CAN) |
| | | to payment recipient. |
| | | A customer may have multiple |
| | | MANs or only one MAN. There |
| | | is only one user-defined MAN |
| | | per Division ID. |
| | | With the advent of multiple |
| | | currencies for AP Control |
| | | transactions, the customer will be |
| | | able to create a user-defined MAN |
| | | that contains French characters. |
| Commercial | ControlDivision | Definition: This ID represents a |
| Credit Card | | customer segment that is relevant |
| | | to the way customer does |
| | | business. It is a 5 digit number |
| | | assigned by the TSYS vendor also |
| | | called “TSYS Level 2 Division |
| | | ID”. It supports CCER's financial |
| | | tracking and reporting. |
| | | Companies can have anywhere |
| | | from one to dozens of Division |
| | | IDs, each one usually associated |
| | | with a separate user-defined MAN. |
| | | It is supplied to customer and |
| | | PMGR by CCER. |
| Commercial | ExpirationDate | Definition: AP Control Expiration |
| Credit Card | Duration | Date is a date field in the payment |
| | | file. However, for the enrichment |
| | | tool, this element is expressed as a |
| | | number of calendar days that the |
| | | AP Control CAN is valid, from |
| | | batch date to expiration date. |
| | | Customer has the option to |
| | | a) Accept the AP Control |
| | | expiration date default, which is |
| | | the last day of the month |
| | | following the transaction date; |
| | | OR b) Define a different default |
| | | expiration date. |
| | | The value is expressed as a |
| | | number of calendar days that |
| | | PMGR will translate into a |
| | | calendar date. Value is numeric, |
| | | from 1 to 365. |
| Commercial | PaymentTolerance | Definition: The payment |
| Credit Card | Over | tolerance threshold for an AP |
| | | control transaction defines the |
| | | maximum percentage over the |
| | | payment amount that can be |
| | | authorized for payment. |
| | | The values in the payment |
| | | tolerance over and under fields |
| | | do not have to be the same. |
| | | Values on the PMGR side are |
| | | entered as a whole number |
| | | between 0 and 100, which CCER |
| | | translates to a maximum |
| | | authorized amount. |
| Commercial | PaymentTolerance | Definition: The payment |
| Credit Card | Under | tolerance threshold for an AP |
| | | control transaction defines the |
| | | maximum percentage under the |
| | | payment amount that can be |
| | | authorized for payment. |
| | | The values in the payment |
| | | tolerance over and under fields |
| | | do not have to be the same. |
| | | Values on the PMGR side are |
| | | entered as a whole number |
| | | between 0 and 100, which CCER |
| | | translates to minimum authorized |
| | | amount. |
| All | EDDHandlingCode | Definition: Code that triggers the |
| | | delivery of enhanced remittance |
| | | functionality. Customer has the |
| | | option to set information and a |
| | | default for their company. |
| | | Values are: |
| | | U Triggers the sending of PMP |
| | | enhanced remittance |
| | | D Payment only |
| | | Other codes are available if |
| | | needed for ACH CTX |
| | | payments (optionally used to |
| | | identify tran handling code in |
| | | ACH CTX payments). |
| All | EDDBillerID | EDD Biller ID. Identifies the |
| | | template to be used when issuing |
| | | enhanced remittance Information. |
| | | Similar to check template in that |
| | | it dictates the information to be |
| | | included and what it will look like. |
| | | Passed to EDD for use in |
| | | preparing and transmitting the |
| | | enhanced remittance information |
| | | to the payee. |

In an example embodiment, the payment manager logic 124 may further include a smart routing engine 140. In such an arrangement, the payment manager logic 124 may be configured to receive payment data from a customer, determine a payment key from the payment data, and use the payment key to retrieve supplemental payment data from a data repository 127, as previously described. However, with the routing engine 140, the routing engine 140 may be used to determine the payment method to be used based on the supplemental payment data (e.g., the recipient of the payee, the dollar amount of the transaction, etc.). For example, the customer may be permitted to leave blank the data segment for the payment method type, such that the routing engine is permitted to choose the most efficient (e.g., lowest cost to the customer) payment method. For example, if the recipient accepts credit card payments, then paying via credit card may be a lower cost alternative than paying by check (e.g., once credit card rewards programs are taken into account). However, if the recipient does not accept credit card payments, then the routing engine 140 may determine that payment needs to be sent via check. Hence, the customer may provide a payment file for a series of transactions without a payment method specified, and in each case the routing engine 140 may determine the most efficient payment method to be used. In other embodiments, other parameters may be taken into account, such as speed of delivery of the payment. For example, if the routing engine 140 determines that a payment is due on the current day, it may determine to use a same day checking payment method rather than a regular checking payment method. As another example, the routing engine 140 may perform routing based on foreign exchange currency conversion rates (e.g., by determining whether to use purchased currency versus whether to use available currency in a given jurisdiction). As another example, the routing engine 140 may perform routing based on country specific clearing times of ACH transfers. For example, if the clearing time in a given jurisdiction is five days instead of two days, then an alternative (e.g., quicker) payment mechanism may be utilized. In one embodiment, the customer may be provided with a user interface that permits the customer to configure business rules for processing payments. For example, the business rules may be configured to permit a payment-related parameter to be compared to a threshold, and then determine which payment channel should be used based on the results of the comparison. For example, in the previous example, the customer may configure a business rule that sets a threshold (e.g., three days), such that a first payment channel is used if the clearing time is below the threshold and a second payment channel is used if the clearing time meets exceeds the threshold. As another example, the customer may configure a business rule that sets a dollar value threshold, such that a first payment channel is used if the dollar value of the payment is below the threshold and a second payment channel is used if the dollar value of the payment meets or exceeds the threshold. As another example, the customer may configure a business rule that sets a payment urgency threshold, such that a first payment channel is used if the amount of time until the payment is due is below the threshold and a second payment channel is used if the amount of time until the payment is due meets or exceeds the threshold. Such a user interface may therefore allow the manner in which the routing engine 140 operates to be customized on a customer-by-customer basis.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings. The present embodiments contemplate methods, systems and program products on any machine-readable media for accomplishing its operations. The embodiments of may be implemented using an existing computer processor, or by a special purpose computer processor incorporated for this or another purpose or by a hardwired system.

As noted above, embodiments within the scope of this disclosure include program products comprising non-transitory machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the embodiments might include a general purpose computing computers in the form of computers, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. Input devices, as described herein, include a keyboard, a keypad, a mouse, joystick or other input devices performing a similar function. The output devices, as described herein, include a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A computer-implemented method for processing a payment request from a customer via a graphical user interface, the method comprising:
receiving, from an accounts payable system, by a payment manager logic of a bank computing system comprising at least one processor and non-transitory computer-readable media, the computer-readable media having embodied thereon the payment manager logic, a payment file comprising payment data from a commercial enterprise customer, the payment data including transactional data for payments to be made on behalf of the commercial enterprise customer to payment recipients, wherein the payment data is associated with a parent company or a subsidiary of the commercial enterprise customer, or combination thereof, and wherein the transactional data comprises payment amounts and payment recipient data on behalf of the parent company, the subsidiary, or the combination thereof;
determining whether a customer profile associated with the parent company or the subsidiary of the commercial enterprise customer comprises a data enrichment configuration, the data enrichment configuration provided by the customer via a graphical user interface structured to interact with payment manager logic;
parsing, via the payment manager logic, the payment file to identify a plurality of segments;
generating, via the payment manager logic, a payment key associated with the customer profile according to metadata and specific segments of the payment file, comprising the operations of:
determining, from the metadata of the payment file, a customer identification number associated with the customer profile;
identifying a first opening syntactic tag as a payment method identification tag;
determining a payment method identification value from a first specific element identified based on the first opening syntactic tag and a first closing syntactic tag, the first specific element residing within a first plurality of elements;
identifying a second opening syntactic tag as a customer-designated tag;
identifying a data enrichment key designated by the customer in the data enrichment configuration, wherein the data enrichment key is located within a customer-designated segment of the plurality of segment collections, wherein the customer-designated segment is identified by the second opening syntactic tag and a second closing syntactic tag; and
generating the payment key, the payment key comprising the customer identification number, the payment method identification value, and the data enrichment key;
locating, via a data enrichment tool and based on the data enrichment key and the determination that the customer provided the data enrichment configuration, a data structure corresponding to the data enrichment key;
retrieving, via the data enrichment tool, supplemental payment data comprising logistics data from the data structure corresponding to the data enrichment key;
enriching, via the data enrichment tool, the payment file with the supplemental payment data from the data structure corresponding to the data enrichment key;
determining, by a smart routing engine of the payment manager logic, a payment method based on supplemental payment data; and
transmitting, via the payment manager logic, a payment signal to a payment computer system to effect payment to the recipients in accordance with the payment data, the payment method, the payment key, and the supplemental payment data.

2. The computer-implemented method of claim 1, wherein the logistics data specifies payment recipients and wherein the logistics data includes at least the payment channel and the delivery timeline.

3. The computer-implemented method of claim 2, wherein the logistics data is preconfigured data stored in the data structure prior to receipt of the transactional data.

4. The computer-implemented method of claim 1, wherein determining a plurality of segment collections in the payment file further comprises:
providing, to the customer, an option to add an additional segment to the segment collection, wherein the additional segment holds the data enrichment key, and wherein the additional segment is structured to be backwards compatible with non-enriching accounts payable systems.

5. The computer-implemented method of claim 1, wherein the payment key specifies a sub-entity of the customer.

6. The computer-implemented method of claim 5, wherein transmitting the payment signal comprises transmitting a template, and wherein the template is a check template that includes a name and address of the sub-entity to a computerized check printing system to enable the computerized check printing system to print the name and address of the sub-entity on a printed check.

7. The computer-implemented method of claim 1, wherein the bank computing system further comprises a routing engine, and wherein the payment computer system is associated with a payment channel and a delivery timeline, the delivery timeline selected at least in part based on an evaluation of the payment key, by the routing engine.

8. The computer-implemented method of claim 7, wherein the routing engine is configured to specify appearance of a payment medium associated with the payment channel based on a template selected by the routing engine using the payment key, and wherein the routing engine is further configured to determine a national currency with which to effect payment, the determination based on an analysis of currency exchange rates.

9. The computer-implemented method of claim 7, wherein the payment key comprises a data field designating the payment method indicative of a payment channel preferred by the customer, and wherein the routing engine is structured to automatically select a payment channel with a lowest cost to the customer if the data field designating the payment method is null.

10. The computer-implemented method of claim 7, wherein the routing engine is further configured to automatically evaluate rewards information for the customer as part of selecting the payment channel.

11. The computer-implemented method of claim 7, wherein the routing engine is further configured to automatically evaluate a due date of the payment as part of selecting the payment channel.

12. The computer-implemented method of claim 7, wherein the routing engine is further configured to automatically select a payment channel from a customer-defined preference list, and wherein the payment channel is selected based on a monetary threshold.

13. The computer-implemented method of claim 7, wherein the routing engine is further configured to automatically select a payment channel from a customer-defined preference list, and wherein the payment channel is selected based on a transaction clearing time threshold.

14. A computer system comprising at least one processor and memory having instructions stored therein that, when executed by the processor, cause the processor to:
receive, from an accounts payable system, by a payment manager logic of a bank computing system comprising a processor and non-transitory computer-readable media, the computer-readable media having embodied thereon the payment manager logic, a payment file comprising payment data from a commercial enterprise customer, the payment data including transactional data for payments to be made on behalf of the commercial enterprise customer to payment recipients, wherein the payment data is associated with a parent company or a subsidiary of the commercial enterprise customer, or combination thereof, and wherein the transactional data comprises payment amounts and payment recipient data on behalf of the parent company, the subsidiary, or the combination thereof;
determine whether a customer profile associated with the parent company or the subsidiary of the commercial enterprise customer comprises a data enrichment configuration, the data enrichment configuration provided by the customer via a graphical user interface structured to interact with payment manager logic;
parse, via the payment manager logic, the payment file to identify a plurality of segments;
generate, via the payment manager logic, a payment key associated with the customer profile according to metadata and specific segments of the payment file, comprising the operations of:
determine, from the metadata of the payment file, a customer identification number associated with the customer profile;
identify a first opening syntactic tag as a payment method identification tag;
determine a payment method identification value from a first specific element identified based on the first opening syntactic tag and a first closing syntactic tag, the first specific element residing within a first plurality of elements;
identify a second opening syntactic tag as a customer-designated tag;
identify a data enrichment key designated by the customer in the data enrichment configuration, wherein the data enrichment key is located within a customer-designated segment of the plurality of segment collections, wherein the customer-designated segment is identified by the second opening syntactic tag and a second closing syntactic tag; and
generate the payment key, the payment key comprising the customer identification number, the payment method identification value, and the data enrichment key;
locate, via a data enrichment tool and based on the data enrichment key and the determination that the customer provided the data enrichment configuration, a data structure corresponding to the data enrichment key;
retrieve, via the data enrichment tool, supplemental payment data comprising logistics data from the data structure corresponding to the data enrichment key;
enrich, via the data enrichment tool, the payment file with the supplemental payment data from the data structure corresponding to the data enrichment key;
determine, by a smart routing engine of the payment manager logic, a payment method based on supplemental payment data; and
transmit, via the payment manager logic, a payment signal to a payment computer system to effect payment to the recipients in accordance with the payment data, the payment method, the payment key, and the supplemental payment data.

15. The computer system of claim 14, wherein the logistics data specifies payment recipients and wherein the logistics data includes at least the payment channel and the delivery timeline.

16. The computer system of claim 15, wherein the logistics data is preconfigured data stored in the data structure prior to receipt of the transactional data.

17. The computer system of claim 14, wherein determining a plurality of segment collections in the payment file further comprises:
provide, to the customer, an option to add an additional segment to the segment collection, wherein the additional segment holds the data enrichment key, and wherein the additional segment is structured to be backwards compatible with non-enriching accounts payable systems.

18. The computer system of claim 14, wherein the payment key specifies a sub-entity of the customer.

19. The computer system of claim 18, wherein transmitting the payment signal comprises transmitting the template, and wherein the template is a check template that includes a name and address of the sub-entity to a computerized check printing system to enable the computerized check printing system to print the name and address of the sub-entity on a printed check.

20. A non-transitory computer readable media having computer-executable instructions embodied therein that, when executed by a processor of a computing system, causes the computing system to perform operations, the operations comprising:
receiving, from an accounts payable system, by a payment manager logic of a bank computing system, a payment file comprising payment data from a commercial enterprise customer, the payment data including transactional data for payments to be made on behalf of the commercial enterprise customer to payment recipients, wherein the payment data is associated with a parent company or a subsidiary of the commercial enterprise customer, or combination thereof, and wherein the transactional data comprises payment amounts and payment recipient data on behalf of the parent company, the subsidiary, or the combination thereof;
determining whether a customer profile associated with the parent company or the subsidiary of the commercial enterprise customer comprises a data enrichment configuration, the data enrichment configuration provided by the customer via a graphical user interface structured to interact with payment manager logic;
parsing, via the payment manager logic, the payment file to identify a plurality of segments;
generating, via the payment manager logic, a payment key associated with the customer profile according to metadata and specific segments of the payment file, comprising the operations of:
determining, from the metadata of the payment file, a customer identification number associated with the customer profile;
identifying a first opening syntactic tag as a payment method identification tag;
determining a payment method identification value from a first specific element identified based on the first opening syntactic tag and a first closing syntactic tag, the first specific element residing within a first plurality of elements;
identifying a second opening syntactic tag as a customer-designated tag;
identifying a data enrichment key designated by the customer in the data enrichment configuration, wherein the data enrichment key is located within a customer-designated segment of the plurality of segment collections, wherein the customer-designated segment is identified by the second opening syntactic tag and a second closing syntactic tag; and
generating the payment key, the payment key comprising the customer identification number, the payment method identification value, and the data enrichment key;
locating, via a data enrichment tool and based on the data enrichment key and the determination that the customer provided the data enrichment configuration, a data structure corresponding to the data enrichment key;
retrieving, via the data enrichment tool, supplemental payment data comprising logistics data from the data structure corresponding to the data enrichment key;
enriching, via the data enrichment tool, the payment file with the supplemental payment data from the data structure corresponding to the data enrichment key; and
determining, by a smart routing engine of the payment manager logic, a payment method based on supplemental payment data; and
transmitting, via the payment manager logic, a payment signal to a payment computer system to effect payment to the recipients in accordance with the payment data, the payment method, the payment key, and the supplemental payment data.

21. The computer-implemented method of claim 1, wherein the smart routing engine determines the payment method based on a type of available payment method having a lowest relative cost.

22. The computer-implemented method of claim 1, wherein the smart routing engine determines the payment method based on a type of available payment method allowable for a particular payment recipient.

23. The computer-implemented method of claim 1, wherein the smart routing engine determines the payment method based on clearing time.

24. The computer-implemented method of claim 1 further comprising:
providing, to the customer, a user interface for inputting business rules, wherein the smart routing engine operates based on business rules provided by the customer.
